(19) United States
(12) Patent Application Publication
(10) Pub. No.: US 2022/0250676 A1
(43) Pub. Date: Aug. 11, 2022

(54) MOTOR DRIVE SYSTEM

(71) Applicants: DENSO CORPORATION, Kariya-city (JP); TOYOTA JIDOSHA KABUSHIKI KAISHA, Toyota-shi (JP); JTEKT CORPORATION, Kariya-shi (JP)

(72) Inventors: HIROKI TOMIZAWA, Kariya-city (JP); HISASHI KAMEYA, Kariya-city (JP); SYUJI KURAMITSU, Kariya-city (JP); AKIRA TAKESAKI, Kariya-city (JP); MASAYA TAKI, Kariya-city (JP); MASAHARU YAMASHITA, Toyota-shi (JP); YOSUKE YAMASHITA, Toyota-shi (JP); SHINTARO TAKAYAMA, Toyota-shi (JP); KENJI SHIBATA, Toyota-shi (JP); TOSHIHIRO TAKAHASHI, Osaka (JP); YUJI FUJITA, Osaka (JP); KENICHI ABE, Osaka (JP); YUGO NAGASHIMA, Osaka (JP)

(21) Appl. No.: 17/660,806

(22) Filed: Apr. 26, 2022

Related U.S. Application Data
(63) Continuation of application No. PCT/JP2020/039342, filed on Oct. 20, 2020.

(30) Foreign Application Priority Data
Oct. 31, 2019 (JP) 2019-199087

(51) Int. Cl. B62D 5/04; B62D 5/00

(52) U.S. Cl. CPC B62D 5/0484; B62D 5/0421; B62D 5/046; B62D 5/006

(57) ABSTRACT

A motor drive system is provided in a steer-by-wire system in which a steering mechanism and a turning mechanism of a vehicle are mechanically separated. The motor drive system includes a reaction force actuator and a turning actuator. The reaction force actuator functions as a motor configured to output a reaction force torque corresponding to a steering torque of a driver and a road surface reaction force. The turning actuator functions as a motor configured to output a turning torque for turning wheels. Each of the reaction force actuator and the turning actuator includes a plurality of control calculation units provided redundantly and each configured to perform a calculation related to a motor drive control, and a plurality of motor drive units provided redundantly and each configured to drive and output the torque based on a drive signal generated by a corresponding control calculation unit.

### CROSS REFERENCE TO RELATED APPLICATIONS

The present application is a continuation application of International Patent Application No. PCT/JP2020/039342 filed on Oct. 20, 2020, which designated the U.S. and claims the benefit of priority from Japanese Patent Application No. 2019-199087 filed on Oct. 31, 2019. The entire disclosures of all of the above applications are incorporated herein by reference.

### TECHNICAL FIELD

The present disclosure relates to a motor drive system.

### BACKGROUND

In a motor drive system that drives a motor of steer-by-wire system, a plurality of control calculation units that perform calculations related to motor drive and a plurality of motor drive units that drive the motor based on a drive signal generated by the control calculation unit are redundantly provided.

### SUMMARY

The present disclosure provides a motor drive system in a steer-by-wire system in which a steering mechanism and a turning mechanism of a vehicle are mechanically separated. The motor drive system includes a reaction force actuator and a turning actuator. The reaction force actuator functions as a motor configured to output a reaction force torque corresponding to a steering torque of a driver and a road surface reaction force. The turning actuator functions as a motor configured to output a turning torque for turning wheels. Each of the reaction force actuator and the turning actuator includes a plurality of control calculation units provided redundantly and each configured to perform a calculation related to a motor drive control, and a plurality of motor drive units provided redundantly and each configured to drive and output the torque based on a drive signal generated by a corresponding control calculation unit.

### BRIEF DESCRIPTION OF DRAWINGS

The features and advantages of the present disclosure will become more apparent from the following detailed description made with reference to the accompanying drawings. In the drawings:

FIG. 1 is an overall configuration diagram of a motor drive system according to an embodiment applied to a steer-by-wire system;

FIG. 2 is a schematic diagram of the motor drive system of FIG. 1;

FIG. 3 is a diagram showing transmission of an abnormal signal when a failure occurs;

FIG. 4 is a flowchart of a motor drive control stop process when a failure occurs;

FIG. 5A is a time chart showing output changes when a failure occurs in one system; and

FIG. 5B is a diagram showing a relationship between a total current command value of two systems and a current limit value.

### DETAILED DESCRIPTION

For example, a fail-safe control device of a control system is known. When one of two ECUs that control reaction force or turning fails, stops the failed ECU and continues the control by one normal ECU. When one of the two motors fails, the failed steering reaction force motor or turning motor is stopped, and control is continued using one normal motor.

The exemplified control system has two reaction force ECUs (A) and (D), each of which controls a drive of a steering reaction force motor, and two turning ECUs (B) and (C), each of which controls a drive of a turning motor. For example, when one reaction force ECU (A) fails, the device stops the reaction force ECU (A), and continues the drive control of the steering reaction force motor and the turning motor by the one normal reaction force ECU (D) and two turning ECUs (B) and (C).

In the present disclosure, the “reaction force ECU” and the “steering reaction force motor” of the exemplified control system are referred to as a “reaction force actuator”, and the “turning ECU” and the “turning motor” of the exemplified control system are referred to as a “turning actuator”. Further, the “reaction force ECU” and the “steering reaction force motor” of the exemplified control system are respectively referred to as a “control calculation unit of the reaction force actuator” and a “motor drive unit of the reaction force actuator”. The “turning ECU” and “turning motor” of the exemplified control system are respectively referred to as a “control calculation unit of the turning actuator” and a “motor drive unit of the turning actuator”.

Further, the “actuator” in the present disclosure includes not only a mechanical element driven by a drive signal from an outside but also a drive device in which a motor drive unit outputs torque by a drive signal generated by a control calculation unit inside the actuator. The control calculation unit and the motor drive unit in the actuator may be physically integrated or may be separately configured via a signal line.

In of the exemplified control system, a configuration in which the reaction force ECU (A) which is “a control calculation unit of the reaction force actuator” and the turning ECU (B) which is “a control calculation unit of the turning actuator” form a pair and transmit and receive information to and from each other is assumed. If one of the control calculation units of the reaction force actuator fails or a communication between the actuators fails, information input to the control calculation unit of the paired turning actuator also becomes an abnormal value or no information is input to the control calculation unit of the paired turning actuator. The motor drive unit controlled by the control calculation unit of the paired turning actuator may erroneously perform an output, and the vehicle may not be deflected in a direction intended by the driver. Therefore, there is a difficulty from the viewpoint of fail safe.

The present disclosure provides a motor drive system for preventing an erroneous output of another actuator due to a failure of either a reaction force actuator or a turning actuator or a failure of communication between actuators.

An exemplary embodiment of the present disclosure provides a motor drive system in a steer-by-wire system in which a steering mechanism and a turning mechanism of a vehicle are mechanically separated. The motor drive system includes a reaction force actuator and a turning actuator. The reaction force actuator functions as a motor configured to output a reaction force torque corresponding to a steering torque of a driver and a road surface reaction force. The turning actuator functions as a motor configured to output a turning torque for turning wheels.

Each of the reaction force actuator and the turning actuator includes a plurality of control calculation units and a plurality of motor drive units. The plurality of control calculation units are provided redundantly and each configured to perform a calculation related to a motor drive control. The plurality of motor drive units are provided redundantly and each configured to drive and output the torque based on a drive signal generated by a corresponding control calculation unit. For example, in a polyphase brushless motor, the motor drive unit is composed of an inverter that supplies voltage, a polyphase winding wound around a stator, a rotor having a permanent magnet, and the like. In addition, like a multi-winding motor, a rotor or the like may be provided in common in a plurality of motor drive units.

A unit of a combination of the control calculation unit and the motor drive unit corresponding to each other in each of the reaction force actuator and the turning actuator is defined as a “system”. The system in the reaction force actuator and the system in the turning actuator corresponding to each other are paired. The control calculation unit in the reaction force actuator and the control calculation unit in the turning actuator paired with each other perform transmission and reception of information with each other by a communication between the reaction force actuator and the turning actuator.

When a failure occurs in one of the systems in the reaction force actuator or the turning actuator or when a failure occurs in one of the systems in the communication between the reaction force actuator and the turning actuator, the control calculation units in the reaction force actuator and the turning actuator included in the one of the systems in which the failure has occurred stop the motor drive control and the control calculation units in the reaction force actuator and the turning actuator included in another one of the systems which normally operate continue the motor drive control.

In the exemplary embodiment of the present disclosure, in the present disclosure, in the case of a failure of either the reaction force actuator or the steering actuator or in the case of a failure of communication between actuators, erroneous output of another actuator due to the failure is prevented, and the vehicle is deflected in a direction intended by the driver. Further, since the motor drive control is continued by the control calculation unit of the normal system in both the actuators, it is possible to secure the steering function of the vehicle and the reaction force presenting function to the driver. Therefore, the fail-safe function is appropriately realized.

In particular, when a failure occurs in any system in either of the two actuators and the communication between the actuators of the system, in which the failure has occurred, is normal, the control calculation unit of the system in which the failure has occurred transmits an abnormal signal to the control calculation unit of the system paired with the other actuator. The control calculation unit that has received the abnormal signal stops the motor drive control. As a result, the motor drive control can be quickly stopped in the control calculation unit of the system paired with the system in which the failure has occurred.

Hereinafter, one embodiment of a motor drive system of the present disclosure will be described with reference to the drawings. A motor drive system in one embodiment includes two actuators, a reaction force actuator and a turning actuator, in a steer-by-wire system in which a vehicle steering mechanism and a turning mechanism are mechanically separated. Each actuator includes a plurality of control calculation units provided redundantly and a plurality of motor drive units provided redundantly. A unit of a combination of the control calculation unit and the motor drive unit, corresponding to each other in each actuator, is defined as a “system”.

### EMBODIMENT

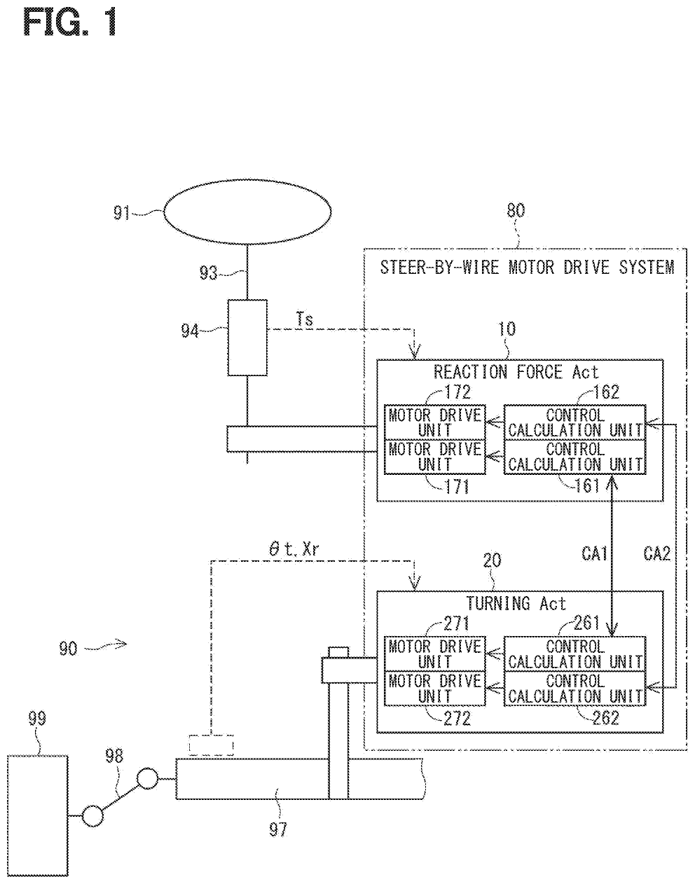

FIG. 1 shows a motor drive system 80 applied to a steer-by-wire system 90 of a vehicle. A steering mechanism of the steer-by-wire system 90 includes a steering wheel 91, a steering shaft 93, a turning torque sensor 94, a reaction force actuator 10, and the like. A turning mechanism of the steer-by-wire system 90 includes a rack 97, a knuckle arm 98, a turning actuator 20, and the like, and wheels 99 are turned by a turning torque output by the turning actuator 20. The wheel 99 shows only one side, and the wheel 99 on the other side is not shown.

The motor drive system 80 includes a reaction force actuator 10 and a turning actuator 20. In the figure below, “Act” means “actuator”. The reaction force actuator 10 functions as a motor that outputs a reaction force torque according to a turning torque of the driver and a road surface reaction force. By rotating the steering wheel 91 so that the reaction force actuator 10 applies the reaction force, an appropriate steering feeling is given to the driver. The turning actuator 20 functions as a motor that outputs the turning torque for turning the wheels 99. When the turning actuator 20 appropriately turns the wheels 99, the vehicle is deflected in a direction intended by the driver.

Each actuator 10 and 20 has a redundant configuration of two systems. That is, the reaction force actuator 10 has two control calculation units 161 and 162 provided redundantly, and two motor drive units 171 and 172 provided redundantly. The turning actuator 20 has two control calculation units 261 and 262 provided redundantly, and two motor drive units 271 and 272 provided redundantly.

Hereinafter, the two systems of each actuator are referred to as “first system” and “second system”. For example, there may be a master-slave relationship between the first system and the second system, and the first system may function as a main (or master) and the second system may function as a sub (or slave). Alternatively, the first system and the second system may have an equal relationship. “1” is added to an end of the code for an element of the first system, and “2” is added to an end of the code to an element of the second system.

Since basic configurations of each of the actuators 10 and 20 is the same, the points where one of the explanations is sufficient will be described by the elements of the reaction force actuator 10 as a representative. The turning actuator 20 can be interpreted by reading the corresponding reference numeral. The control calculation units 161 and 162 are specifically composed of a computer and an ASIC, and perform calculations related to motor drive control. The control calculation units 161 and 162 may also perform control other than motor drive control, but this specification does not refer to other controls. When the control calculation unit “stops the motor drive control”, as will be described later, it does not matter whether to stop the other controls.

Specifically, the control calculation units 161 and 162 include a CPU, ROM, RAM, I/O (not shown), a bus line connecting these configurations, and the like. The control calculation units 161 and 162 performs required control by executing software processing or hardware processing. The software processing may be implemented by causing the CPU to execute a program. The program may be stored beforehand in a memory device such as a ROM, that is, in a readable non-transitory tangible storage medium. The hardware processing may be implemented by a special purpose electronic circuit.

The motor drive units 171 and 172 drive the motors based on the drive signals generated by the corresponding control calculation units 161 and 162, and output a torque. The motor drive unit is also referred to as a motor driver. For example, in a polyphase brushless motor, the motor drive units 171 and 172 are composed of an inverter that supplies voltage, a polyphase winding wound around a stator, a rotor having a permanent magnet, and the like. The motor drive units 171 and 172 in two systems cooperate to output the torque. For example, the motor drive units 171 and 172 may be configured as a double winding motor in which two polyphase windings are wound around a common stator.

In the figure, an arrow from the control calculation unit 161 to the motor drive unit 171 and an arrow from the control calculation unit 162 to the motor drive unit 172 respectively indicate a drive signal of each system. In the case of a polyphase brushless motor, the drive signal is a switching pulse signal of an inverter, and is typically a PWM signal or the like. The control calculation unit 161 or 162 in the reaction force actuator 10 acquires steering torque Ts detected by the steering torque sensor 94, a road surface reaction force, and the like, and generates the drive signal on the basis of these pieces of information. The control calculation unit 261 or 262 in the rolling actuator 20 acquires a steering angle or rolling angle θt, a rack stroke Xr, and the like, and generates the drive signal on the basis of these pieces of information.

As described above, in the present specification, a term “actuator” is used as a unit drive device including a plurality of control calculation units and a plurality of motor drive units. For example, in Patent Literature 1 (JP 4848717 B2), apart from the ECU that calculates the drive signal, only the motor main body portion, which is a mechanical element, is treated as an actuator, and the interpretation of term “actuator” is different from the present specification. The actuator of the present embodiment may be a so-called “mechatronics-integrated” motor in which the control calculation unit and the motor drive unit are physically integrated. Alternatively, as a so-called “mechatronics separated type” motor, the control calculation unit and the motor drive unit may be separately configured via a signal line.

The first system of the reaction force actuator 10 and the first system of the turning actuator 20 form a pair with each other. Further, the second system of the reaction force actuator 10 and the second system of the turning actuator 20 form a pair with each other. In the reaction force actuator and the turning actuator, the control calculation units of the systems paired with each other transmit and receive information to and from each other by a communication CA1 and CA2 between the actuators.

The “information transmitted to and received from each other” by the communication between the actuators includes at least abnormality information of each of the actuators 10 and 20. Abnormalities in the control calculation unit include data abnormality, arithmetic processing abnormality, internal communication abnormality, synchronization abnormality, and the like.

Abnormalities in the motor drive unit include abnormality in a switching element of the inverter, short circuit of a relay provided in the circuit, open failure, disconnection failure of the motor winding, and the like. When these failures occur, the actuators 10 and 20 transmit and receive the information to and from each other.

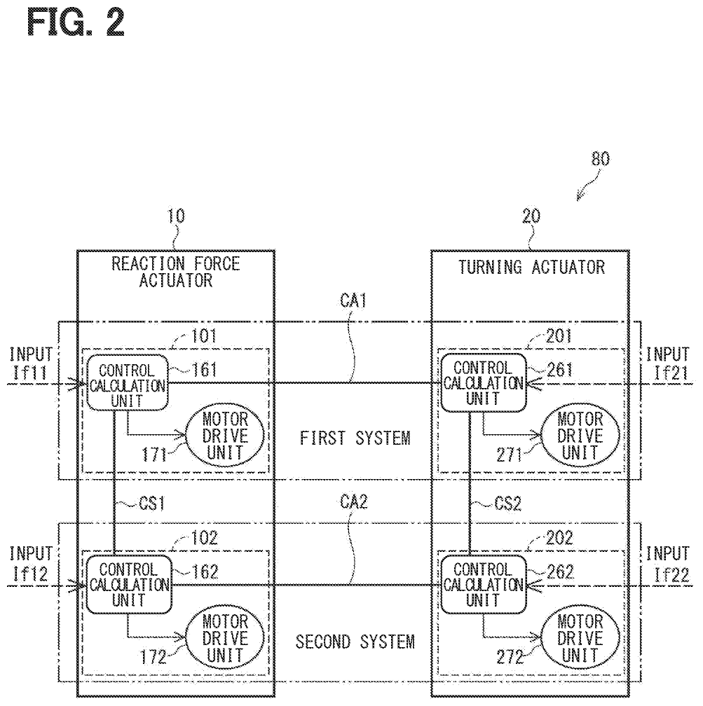

FIG. 2 shows a simplified schematic diagram of the motor drive system 80 of FIG. 1. That is, the configuration as the steer-by-wire system 90 is omitted, and the configuration of the “motor drive system 80 including the reaction force actuator 10 and the turning actuator 20 having a two-system redundant configuration” is simply illustrated. In FIG. 2, a broken line frame is shown for the first system and the second system of the actuators 10 and 20, and the reference numerals are given to “first system 101, 201” and “second system 102, 202”. However, in the following explanation, a code of the system may be omitted as appropriate in places that are obvious from the context.

Although it partially overlaps with the description of FIG. 1, the configurations of the actuators 10 and 20 will be described again. In the reaction force actuator 10, the control calculation unit 161 of the first system 101 and the control calculation unit 162 of the second system 102 are provided redundantly, and the motor drive unit 171 of the first system 101 and the motor drive unit 172 of the second system 102 are provided redundantly. In the turning actuator 20, the control calculation unit 261 of the first system 201 and the control calculation unit 262 of the second system 202 are provided redundantly, and the motor drive unit 271 of the first system 201 and the motor drive unit 272 of the second system 202 are provided redundantly.

In the configuration of FIG. 2, in each of the actuators 10 and 20, information such as a signal of the turning torque Ts, a feedback signal of the turning angle θt and the rack stroke Xr, and the like are redundantly input to the control calculation unit of each system. That is, instead of one information signal being branched and input to the control calculation unit of each system, an information signal generated exclusively for the first system is input to the first system and an information generated exclusively for the second system is input is input to the second system.

For example, regarding the reaction force actuator 10, an information item If11 is redundantly input to the control calculation unit 161 of the first system 101, and an information item If12 is redundantly input to the control calculation unit 162 of the second system 102. Further, regarding the turning actuator 20, an information item If21 is redundantly input to the control calculation unit 261 of the first system 201, and an information item If22 is redundantly input to the control calculation unit 262 of the second system 202. As a result, if an input unit of the control calculation unit of one system fails, the control calculation unit of the other system can acquire correct information.

Further, the control calculation unit 161 of the first system 101 and the control calculation unit 162 of the second system 102 in the same reaction force actuator 10 mutually transmit and receive information by the communication CS1 between the systems. The control calculation unit 261 of the first system 201 and the control calculation unit 262 of the second system 202 in the same turning actuator 20 mutually transmit and receive information by the communication CS2 between systems. The information transmitted to each other by the communication CS1 and CS2 between the systems includes, for example, an input value from the outside, a current command value calculated by the control calculation unit, a current limit value, an actual current to be fed back, and the like. In addition, abnormal signals of the respective systems are mutually transmitted and received.

As described above, the first system 101 of the reaction force actuator 10 and the first system 201 of the turning actuator 20 form a pair with each other, and the second system 102 of the reaction force actuator 10 and the second system 202 of the turning actuator 20 form a pair with each other. That is, the systems denoted by the same number form a pair with each other. However, the terms “first system” and “second system” are only assigned for convenience, and it is free to decide which of the two systems is “first system” and which of the two system is “second system”. Depending on the system, the “first system of the reaction force actuator” and the “second system of the turning actuator” may form a pair with each other, and the “second system of the reaction force actuator” and the “first system of the turning actuator” may form a pair with each other.

The control calculation units of the systems forming a pair with each other in the reaction force actuator 10 and the turning actuator 20 mutually transmit and receive information through the inter-actuator communication. Therefore, the control calculation units 161 and 261 of the first system of the actuators 10 and 20 mutually transmit and receive information by the communication CA1 between the actuators. The control calculation units 162 and 262 of the second system of the actuators 10 and 20 mutually transmit and receive information by the communication CA2 between the actuators.

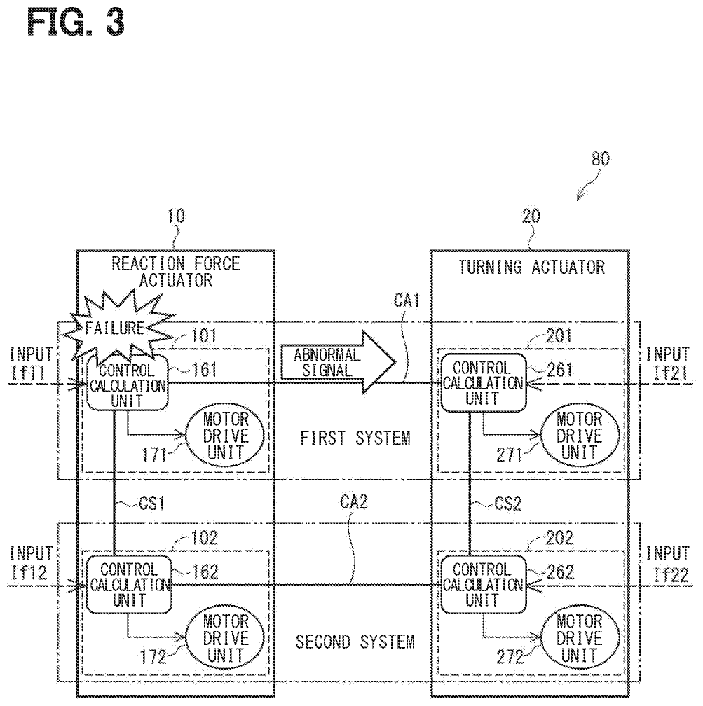

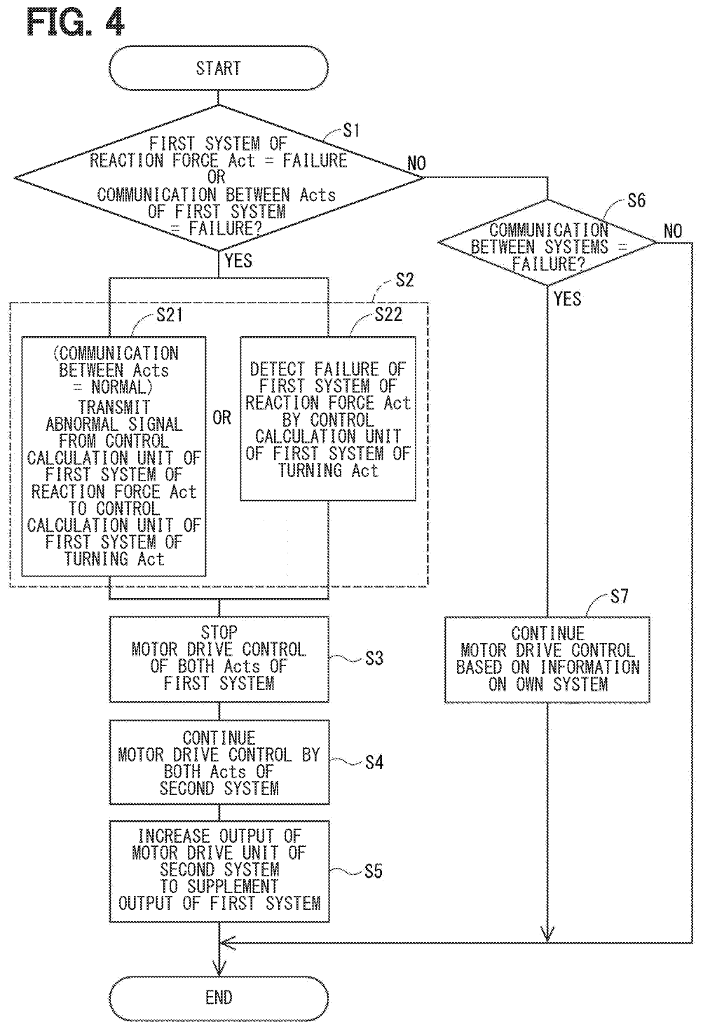

Next, with reference to FIGS. 3, 4, 5A and 5B, the operation of the motor drive system 80 will be described by taking as an example a case where a failure occurs in the first system of the reaction force actuator 10. FIG. 3 shows an example in which an abnormality signal is transmitted when a failure occurs in the motor drive system 80 of FIG. 2. In the flowchart of FIG. 4, the symbol “S” indicates a step.

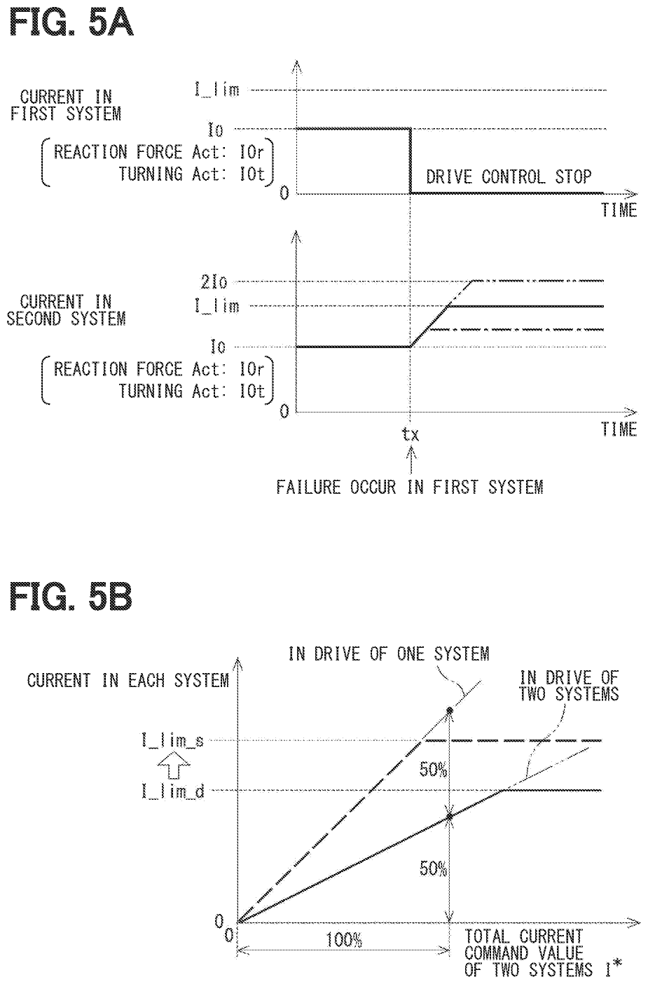

In FIGS. 5A and 5B, in the motor drive by a current feedback control, an output change of the motor drive unit at the time of failure is represented by a current command value after a limitation by the control calculation unit of each system. A current flows from the inverter of the motor drive unit to the multi-phase winding based on the current command value in each actuator 10 and 20, so that the motor drive unit of each actuator 10 and 20 outputs a desired torque.

As shown in FIG. 5A, in a normal time before the time tx, current I₀r having a current limit value I_lim or less and equivalent to each other flows through the motor drive units 171 and 172 of the first system and the second system of the reaction force actuator 10. Further, current I₀t having a current limit value I_lim or less and equivalent to each other flows through the motor drive units 271 and 272 of the first system and the second system of the turning actuator 20. A relationship between the normal current I₀r of the reaction force actuator 10 and the normal current I₀t of the turning actuator 20 may or may not be correlated depending on the applications and characteristics of the actuators 10 and 20. Hereinafter, focusing only on the fact that the currents are the same between the first system and the second system, the actuators 10 and 20 are not distinguished, and the normal current is simply referred to as “I₀”.

Then, it is assumed that a failure has occurred in the first system of the reaction force actuator 10 at time tx, and at this time, it is determined as YES in S1 of FIG. 4. Further, when a failure occurs in the communication CA1 between actuators of the first system, it is determined as YES in S1. If YES in S1, in S2, the control calculation unit 261 of the first system of the turning actuator 20 recognizes the occurrence of a failure in the first system of the reaction force actuator 10 by one of two steps of S21 and S22. In S21, it is assumed that the communication between the actuators is normal.

In S21, as shown in FIG. 3, an abnormality signal is transmitted from the control calculation unit 161 of the first system of the reaction force actuator 10 to the control calculation unit 261 of the first system of the turning actuator 20. That is, the abnormal signal is transmitted from the “control calculation unit of the system in which the failure has occurred in the actuator in which the failure has occurred” to the control calculation unit of the same system of the other actuator. The control calculation unit 261 of the turning actuator 20 that has received the abnormality signal stops the motor drive control in S3. Therefore, in S3, the control calculation units 161 and 261 of the first system of both actuators 10 and 20 both stop the motor drive control.

Further, in S22, the control calculation unit 261 of the first system of the turning actuator 20 detects a failure of the first system of the reaction force actuator 10. In S3, the control calculation unit 161 of the first system of the reaction force actuator 10 stops the motor drive control, and the control calculation unit 261 of the first system of the turning actuator 20 that detects the failure stops the motor drive control by itself. Similarly, when the control calculation unit 261 of the first system of the turning actuator 20 detects that a failure has occurred in the communication CA1 between actuators of the first system, the control calculation unit 261 stops the motor drive control by itself.

In S4, in both actuators 10 and 20, the motor drive is continued by the control calculation units 162 and 262 of the second system which is normal. In S5, the control calculation units 162 and 262 of the second system, which is a normal side system, increase the outputs of the motor drive units 172 and 272 of the second system with respect to the normal time of both systems so as to supplement the outputs of the motor drive units 171 and 271 of the first system, which is a failure side system.

As shown in FIG. 5A, the drive control is stopped at time tx, and the current I₀ of the first system becomes 0. Therefore, the motor drive units 172 and 272 of the second system can energize twice the current (2I₀) as normal as shown by the alternate long and short dash line, and the total output of the two systems before the failure can be completely maintained. However, when twice the current (2I₀) as normal exceeds the current limit value I_lim, the current of the second system may be increased to the current limit value I_lim as shown by the solid line. Alternatively, as shown by the alternate long and short dash line, the current of the second system may be increased to a value between the normal current I₀ and the current limit value I_lim.

The above mentioned examples correspond to the control of “increasing the output of the motor drive unit of the second system with respect to the normal time of both systems so as to supplement the output of the motor drive unit of the first system”. That is, the control is not limited to completely maintaining the total output of the two systems before the failure, and supplements at least a part of the output of the motor drive of the first system by increasing the current of the second system as much as possible with respect to the normal current. By appropriately increasing the output of the motor drive unit of the second system, it is possible to prevent heat generation due to an excessive current.

Further, as shown in FIG. 5B, the current limit value I_lim_s of the normal system at the time of failure of one system may be increased with respect to the current limit value I_lim_d in the normal state of both systems. As a result, the output of the motor drive unit of the first system can be supplemented by one system drive of the second system until the total current command value I* of the two systems is larger.

Subsequently, the process in the case of NO in S1 of FIG. 4 will be described. In S6, it is determined whether the communication CS1 or CS2 between the systems in the reaction force actuator 10 or the steering actuator 20 has failed. If YES in S6, the control calculation units 161 and 162 of each system of the reaction force actuator 10 and the control calculation units 261 and 262 of each system of the turning actuator 20 continue the motor drive control based on the information of only the own system without stopping the motor drive control in S7. If the communications CS1 and CS2 between the systems are also normal, it is determined as NO in S6, and the motor drive control in the normal state is continued.

In Patent Literature 1, only the motor directly controlled by the failed ECU is stopped, and the motor controlled by the paired ECU that communicates with each other is continued as it is. In this configuration, for example, when the first system of the reaction force actuator 10 fails, the motor drive unit 271 controlled by the control calculation unit 261 of the first system of the steering actuator 20 erroneously perform an output, and the vehicle may not be deflected in a direction intended by the driver.

On the other hand, in the present embodiment, in the case of a failure of either the reaction force actuator 10 or the steering actuator 20 or in the case of a failure of communication between actuators, erroneous output of the other actuator due to the failure is prevented, and the vehicle is deflected in a direction intended by the driver. Further, since the motor drive control is continued by the control calculation unit of the normal system in both the actuators 10 and 20, it is possible to secure the steering function of the vehicle and the reaction force presenting function to the driver. Therefore, the fail-safe function is appropriately realized.

Here, the motor drive control can be quickly stopped by transmitting an abnormal signal from the control calculation unit on the failed actuator side as a means for the other actuator to acquire information on the occurrence of the failure. Alternatively, the control calculation unit on the normal actuator side detects the failure, so that the failure information can be recognized even when the communication between the actuators is a failure. Further, by using both means in combination, it is possible to perform the stop process of the motor drive control more quickly and surely, and the reliability is further improved.

In addition, the control calculation units of two systems in the same actuator transmit and receive information to and from each other through the communication between the systems, so that the motor drive units of two systems can be operated in cooperation under normal conditions to realize the motor drive with a good output balance. However, when only the communication between the systems fails, the control calculation unit does not stop the motor drive control, but continues the motor drive control based on only information of the own system. As a result, the total output of the two systems can be maintained as high as possible even if the output balance between the systems may be slightly biased.

In addition, redundancy can be maintained.

### OTHER EMBODIMENTS

In the above embodiment, the communication between the systems is performed by each actuator, information to the control calculation unit is redundantly input, and the output of the motor drive unit is increased when one system is driven. However, in other embodiments, the communication between the systems may be performed by only one actuator, and information to the control calculation unit may be redundantly input by only one actuator. Alternatively, the output of the motor drive unit may be increased when one system is driven by using only one actuator. Further, when there is no request from the system, it is not necessary to perform the communication between the systems, the redundant input of information, and the output increase process when one system is driven in any system. In the above embodiment, as a means for the other actuator to acquire information on the occurrence of a failure, abnormality information is transmitted from the control calculation unit on the failed actuator side. However, in other embodiments, the control calculation unit on the failed actuator side may stop the communication between the actuators.

The present disclosure is not limited to the embodiment described above but various modifications may be made within the scope of the present disclosure.

The control calculation unit and method described in the present disclosure may be implemented by a special purpose computer which is configured with a memory and a processor programmed to execute one or more particular functions embodied in computer programs of the memory. Alternatively, the control calculation unit described in the present disclosure and the method thereof may be realized by a dedicated computer configured as a processor with one or more dedicated hardware logic circuits. Alternatively, the control calculation unit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A motor drive system in a steer-by-wire system in which a steering mechanism and a turning mechanism of a vehicle are mechanically separated, the motor drive system comprising:
a reaction force actuator that functions as a motor configured to output a reaction force torque corresponding to a steering torque of a driver and a road surface reaction force; and
a turning actuator that functions as a motor configured to output a turning torque for turning wheels, wherein
each of the reaction force actuator and the turning actuator includes
a plurality of control calculation units provided redundantly and each configured to perform a calculation related to a motor drive control, and
a plurality of motor drive units provided redundantly and each configured to drive based on a drive signal generated by a corresponding control calculation unit and output the torque,
a unit of a combination of the control calculation unit and the motor drive unit corresponding to each other in each of the reaction force actuator and the turning actuator is defined as a system,
the system in the reaction force actuator and the system in the turning actuator corresponding to each other are paired,
the control calculation unit in the reaction force actuator and the control calculation unit in the turning actuator paired with each other perform transmission and reception of information with each other by a communication between the reaction force actuator and the turning actuator, and
when a failure occurs in one of the systems in the reaction force actuator or the turning actuator or when a failure occurs in one of the systems in the communication between the reaction force actuator and the turning actuator,
the control calculation units in the reaction force actuator and the turning actuator included in the one of the systems in which the failure has occurred stop the motor drive control, and
the control calculation units in the reaction force actuator and the turning actuator included in another one of the systems which normally operate continue the motor drive control.

2. The motor drive system according to claim 1, wherein
when the failure occurs in the one of the systems in the reaction force actuator or the turning actuator and the communication between the actuators in the one of the systems is normal, the control calculation unit in the one of the systems of the reaction force actuator or the turning actuator in which the failure has occurred transmits an abnormal signal to the control calculation unit in the paired system of the reaction force actuator or the turning actuator in which the failure has not occurred and the control calculation unit that has received the abnormal signal stops the motor drive control.

3. The motor drive system according to claim 1, wherein
when the control calculation unit in one of the systems in the reaction force actuator or the turning actuator detects that the failure has occurred in another one of the systems paired with the one of the systems or detects that the failure has occurred in the one of systems in the communication between the actuators, the control calculation unit in the one of systems stops the motor drive control.

4. The motor drive system according to claim 1, wherein
the plurality of control calculation units in at least one of the reaction force actuator and the turning actuator perform transmission and reception of information with each other by a communication between the systems.

5. The motor drive system according to claim 4, wherein
when the communication between the systems fails, the control calculation unit of each system continues the motor drive control based on the information of the own system.

6. The motor drive system according to claim 1, wherein
information to the control calculation unit of each system is redundantly input in at least one of the reaction force actuator and the turning actuator.

7. The motor drive system according to claim 1, wherein,
in at least one of the reaction force actuator and the turning actuator, the control calculation unit of the system which is normally operating causes the motor drive unit of the system which is normally operating to output the torque so as to supplement an output of the motor drive unit of the system in which the failure has occurred such that the torque is increased compared when the systems are normal.

8. A motor drive system in a steer-by-wire system in which a steering mechanism and a turning mechanism of a vehicle are mechanically separated, the motor drive system comprising:
a reaction force actuator that functions as a motor configured to output a reaction force torque corresponding to a steering torque of a driver and a road surface reaction force; and
a turning actuator that functions as a motor configured to output a turning torque for turning wheels, wherein
each of the reaction force actuator and the turning actuator includes
a plurality of processors provided redundantly and each configured to perform a calculation related to a motor drive control, and
a plurality of motor drivers provided redundantly and each configured to drive based on a drive signal generated by a corresponding processor and output the torque,
a unit of a combination of the processor and the motor driver corresponding to each other in each of the reaction force actuator and the turning actuator is defined as a system,
the system in the reaction force actuator and the system in the turning actuator corresponding to each other are paired,
the processor in the reaction force actuator and the processor in the turning actuator paired with each other perform transmission and reception of information with each other by a communication between the reaction force actuator and the turning actuator, and
when (i) a failure occurs in one of the systems in the reaction force actuator or the turning actuator or (ii) when a failure occurs in one of the systems in the communication between the reaction force actuator and the turning actuator,
the processors in the reaction force actuator and the turning actuator included in the one of the systems in which the failure has occurred stop the motor drive control, and
the processors in the reaction force actuator and the turning actuator included in another one of the systems which normally operate continue the motor drive control.
